(19) United States
(12) Patent Application Publication
(10) Pub. No.: US 2016/0183551 A1
(43) Pub. Date: Jun. 30, 2016

(54) PROCESS FOR THE PREPARATION OF AN EXPANDED DAIRY PRODUCT AND PRODUCT OBTAINED THEREBY

(71) Applicant: OLYMPIA SRL, Casalpusterlengo (LO) (IT)

(72) Inventor: Luna Fantini, Maccastorna (IT)

(73) Assignee: OLYMPIA SRL, Casalpusterlengo, LO (IT)

(21) Appl. No.: 14/911,834

(22) PCT Filed: May 23, 2014
(86) PCT No.: PCT/EP2014/060645

§ 371 Date: Feb. 12, 2016

(30) Foreign Application Priority Data
Aug. 13, 2013 (IT) LO2013A000004

(51) Int. Cl. A23C 19/09; A23C 19/068

(52) U.S. Cl. CPC A23C 19/0912; A23C 19/0688

(57) ABSTRACT

The invention relates to a process for the preparation of an expanded dairy product having the largest dimension of at least 1 cm, directly from a piece of seasoned cheese, without subjecting the seasoned cheese to grinding, which process consists in subjecting a piece of cheese obtained by cut from a wheel of hard cheese at a distance comprised between 1 mm and 2 cm, to a microwave oven treatment, followed by a quick cooling by air. The invention also relates to the expanded dairy product obtainable thereby.

The present invention is directed to a process for the preparation of an expanded dairy product. More particularly, the process allows the production of pieces whose larger dimension is preferably of at least 1 cm, more preferably of at least 2 cm, even more preferably of at least 5 cm.

In recent decades the snacks and bites market, which represent for kids and teens the fastest and easiest way to get a bite or a snack, has grown enormously. This phenomenon was increased further by the diffusion of vending machines in schools and in the workplace.

Obesity in adolescence is an increasing problem and it is often linked to the increasing use of snacks and bites which present a high content of fats and carbohydrates and a low protein content. It is therefore a very felt problem to replace snacks and bites having low nutritional value with snacks and bites having higher protein content.

EP 1 614 355 describes a granular dairy product obtained from hard cheeses by treatment of the cheeses itself with microwaves. The starting cheese is finely divided and different shapes can be obtained by using molds in which the grinded cheese is placed before being subjected to microwaves. However, the pieces obtained by this process are characterized by considerable friability and fragility which can lead to a considerable fragmentation during the packaging period. Moreover, as described in the patent, the molds are soiled by the cheese grease which melts during the processing and they therefore need to be cleaned between one mold and the subsequent, in addition to causing a loss of food material.

The use of a grinded product may lead to a greater difficulty in product traceability. In fact, during the process, different batches of the same product may be mixed, or different products may be mixed and therefore lead to lower security and certainty on the quality and type of the product used.

Therefore, there is a problem of finding an alternative to the system described in EP 1 614 355 which allows the production of pieces of expanded dairy product having higher breaking strength and a productive standard more connected to the homogeneity of the product originally used. These properties, in addition of being a warranty of a better product preservation, also represent a quality from the point of view of the consumer who appreciates the consistence on the palate, the taste uniformity and the traceability from the source.

The present invention is thus directed to a process for the preparation of an expanded dairy product obtainable directly from a piece of seasoned cheese, preferably seasoned for at least about 6 months, without subjecting the cheese to grind. The process consists in subjecting a piece of cheese to a microwave oven processing, which piece of cheese is obtained by cutting a wheel of hard cheese at a distance from the crust comprised between 1 mm and 2 cm, followed by cooling with air. The distance from the crust is chosen to have a combination of capacity of the cheese to expand together with adequate mechanical strength.

The present invention is also directed to the pieces of cheese with expanded structure obtained therefrom. Seasoned cheeses suitable for the use in the present invention are preferably seasoned for at least about 6 months, for example: Grana Padano, Parmigiano Reggiano, Tipico Lodigiano, Pecorino, and all cheeses of the family of Grana, etc.

Depending on the type of seasoned cheese used and on its seasoning, the distance from the outer edge of the crust varies, preferably in a range comprised between 1 mm and 2 cm. For example, in a 20 months seasoned Grana Padano the distance is preferably comprised between 2 and 4 mm. Preferably the seasoned cheese for use in the present invention is a hard cheese seasoned for 6 months or more.

For a piece of 8 months seasoned Tipico Lodigiano the distance from the outer edge will be preferably comprised between 1 and 3 mm.

The piece of cheese so cut, deprived of the outer part of the crust, with a humidity content lower or equal to 45%, is subjected to a microwave oven processing until an expanded product with a humidity content preferably lower than 10% is obtained. The power of the microwave oven is preferably comprised between 400 and 1.700 watt, better between 800 and 1.500 watt, and the duration of treatment is preferably comprised between 25 and 360 seconds.

The piece, coming from the treatment by microwave, is cooled by forced air in temperature reducer. The air utilized has a temperature preferably comprised between 0° and −40° C., more preferably between 0° and −20° C. The period of treatment may vary in a wide range, preferably it is comprised between 60 and 300 seconds. At cooling completed, the expanded product is stored prior to its packaging.

The final expanded product humidity content is preferably lower than 10%. More preferably is comprised between 2 and 7%.

The microwave treatment can also be performed in an oven under vacuum.

During the microwave treatment the water molecules contained in the cheese evaporate. In this way it is possible to control the energy supply so that the organoleptic and nutritional properties of the product are not damaged.

Calorimetric, organoleptic and nutritional features of the expanded product show that the product is correct from the nutritional point of view (40% of unsaturated fats and only 70 mg of cholesterol in 50 gr: 384 Kcal for 100 gr of expanded product).

By its high protein value, with 33% of protein and the total absence of sugar and carbohydrates, its use is recommended to sportsmen for the high intake of mineral salts and vitamins, also recommended to teens and seniors in physical and psychological stress situations and in both protein diets and food combining diets or other low-calories diets, as it does not stimulate, by the absence of carbohydrates, the production of insulin which promotes the transformation of the carbohydrate into adipose cell.

A daily intake of 20/30 gr of expanded Grana Padano Lodigiano cheese perfectly integrates every diet, fighting cellular aging by its high phosphates, iodine and selenium content.

Recently a study has been implemented, showing a positive effect on blood pressure, due to Lactobacillus Helveticus which develops itself during the preparation of the cheese; it appears that this effect is similar to ace inhibitors and sartans (antihypertensive drugs).

### Production Process

The apical and bottom discs of the hard cheese wheel, being it Grana Padano or Tipico Lodigiano cheese starting from 6 months seasoning or more, are subjected to a milling process of the outer part of the crust with the removal of the first external ⅗mm. Then same process can be applied to the lateral cover part of the cheese wheel. Once the outer part is removed, the disc or the lateral part is subjected to punching which creates sticks of 8 cm length, 8 mm width and 5 mm thickness.

The product so divided can be placed on a silpack carpet or on a teflon mold and then go to the cooking step. The cooking occurs in a microwave oven at a power of 1.100 watt at 100% for 3 minutes. At the moment of the picking up, the temperature reached by the oven is about 137° C.

The product is directly placed in a temperature reducer with forced air at −14° C. for 5 minutes, until the product reaches a temperature of 3° C.

| | Expanded | Expanded | |
|---|---|---|---|
| | product | product | |
| | from | from | |
| | Tipico | Grana | Grana |
| | Lodigiano | Padano | Padano |
| | cheese | cheese | cheese |
| Total Fats | 30% | 38% | 28% |
| Unsaturated Fats | 11% | 14% | |
| Saturated Fats | 19% | 24% | |
| Proteins | 49% | 48% | 33% |
| Carbohydrates | 13% | 6% | 3% |
| Humidity | 3% | 2% | 30% |
| Ashes | 5% | 6% | 6% |
| Energy Value | 518 kcal/100 g | 556 kcal/100 g | 390 kcal/100 g |

### Second Production Process

Starting from a wheel of Parmigiano Reggiano hard cheese or any other type of hard cheese like Pecorino, Sbrintz, etc., the apical and the bottom discs are subjected to a milling process of the outer part of the crust with the removal of the first external 4 mm. The same process is applied to the lateral cover part of the cheese wheel. Once the outer part is removed, the disc or the lateral part is subjected to punching which creates sticks of 2 cm length, 8 mm width and 5 mm thickness. The so divided product is placed on a silpack carpet or in a Teflon containing mold and placed in a microwave oven for baking at a power of 1.400 watt at 100% for 2 minutes. At the moment of the picking up, the temperature reached by the oven is of about 158° C. The product is directly placed in a temperature reducer with forced air at −17° C. for 5 minutes, until the product reaches the temperature of 5° C.

1. Process for preparing an expanded dairy product directly from a piece of seasoned cheese, which expanded diary product preferably has a larger dimension of at least 1 cm, without subjecting the seasoned cheese to grinding, the process consisting in subjecting a piece of cheese to a microwave oven processing, which piece of cheese is obtained by cutting a wheel of hard cheese at a distance from the crust comprised between 1 mm and 2 cm, followed by cooling with air.

2. A process according to claim 1, wherein the seasoned cheese is selected from Grana Padano, Parmigiano Reggiano, Tipico Lodigiano, Pecorino and Sbrinz.

3. A process according to claim 2, wherein the cheese is Grana Padano or Parmigiano Reggiano and the distance from the crust is 2-4 mm, or Tipico Lodigiano and the distance from the crust is 1-3 mm.

4. A process according to claim 1 wherein the microwave oven has a power between 400 and 1700 W, preferably between 800 and 1500 W.

5. A process according claim 1 wherein the cooling air has a temperature comprised between −40° C. and 0° C.

6. A process according to claim 1 wherein the treatment in the microwave oven lasts between 25 s and 360 s.

7. A process according to claim 1 where the treatment with cooling air lasts between 60 s and 300 s.

8. A product with an expanded structure obtainable by the process of claim 1.

9. A product according to claim 8, wherein the water content is lower than 10 weight %.

10. A product according to claim 9, wherein the water content is comprised between 2 and 7 weight %.

11. A product according to claim 8, wherein the seasoned cheese is selected from Grana Padano, Parmigiano Reggiano, Tipico Lodigiano, Pecorino and Sbrinz.
